(19) United States
(12) Patent Application Publication
(10) Pub. No.: US 2007/0279739 A1
(43) Pub. Date: Dec. 6, 2007

(54) Polarization converting light guide panel unit and display device having the same

(75) Inventors: Jae-ho You, Yongin-si (KR); Jee-hong Min, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/714,825

(22) Filed: Mar. 7, 2007

(30) Foreign Application Priority Data
Jun. 5, 2006 (KR) 10-2006-0050477

(51) Int. Cl. G02B 27/28

(52) U.S. Cl. 359/485

(57) ABSTRACT

Provided are a polarization converting light guide panel unit and a display device having the same. The polarization converting light guide panel unit includes a light guide panel which guides light emitted by a light source, and comprising a light transmission pattern through which the light is incident to the light guide panel or exits from the light guide panel and which is disposed on a bottom surface of the light guide panel, and a polarization converting device disposed below the light guide panel, which converts the polarization of light transmitted by the light transmission pattern and transmits the converted light back toward the light guide panel.

### CROSS-REFERENCE TO RELATED PATENT APPLICATIONS

This application claims priority from Korean Patent Application No. 10-2006-0050477, filed on Jun. 5, 2006, in the Korean Intellectual Property Office, the disclosure of which is incorporated herein in its entirety by reference.

### BACKGROUND OF THE INVENTION

1. Field of the Invention

Apparatuses consistent with the present invention relate to a polarization converting light guide panel unit in which a polarization converting performance is improved and to a light efficiency is increased, and a display device having the same.

2. Description of the Related Art

Flat panel displays can be categorized as self-emissive displays, which generate light themselves and form images using the generated light, or non-emissive displays, which form images using light received from another light source. For example, liquid crystal displays (LCDs) are non-emissive displays. Thus, an LCD requires an additional light source, for example, an illumination unit, such as a backlight unit, to form images.

Related art LCDs use only about 5% of the total amount of light emitted from the corresponding light source to form images. Such a low light efficiency results from light absorption in a polarization plate and a color filter. LCDs are manufactured by arranging two substrates, in which electric field generating electrodes are formed, so that the electrodes have surfaces opposite to each other, and by injecting a liquid crystal material between the two substrates. An electric field generated by applying voltages to two electrodes moves liquid crystal molecules of the liquid crystal material, which can be used to form an image. That is, related art LCDs transmit or block light by selectively changing the polarization state of incident light by changing the state of the liquid crystal molecules. Thus, LCDs only transmit light of a specific polarization state. To this end, a polarization plate is provided on both surfaces of the LCDs. The polarization plates disposed on both surfaces of the LCDs are absorption type polarization plates which transmit light polarized in one direction and absorb light polarized in an orthogonal direction. Thus, each polarization plate absorbs about 50% of incident ambient light, resulting in a maximum cause of low light efficiency of related art LCDs.

To address these problems, studies for increasing the light efficiency of LCDs by developing a replacement for the absorption type polarization plates or by converting most light incident on the rear polarization plate to light having the same polarization direction as a polarization direction of the rear polarization plate have been carried out. For example, the light efficiency of LCDs can be increased by attaching a reflection type polarization film having a multi-layer structure, such as a dual brightness enhancement film (DBEF), to a top surface of the light guide panel. However, the additional reflection type polarization film is expensive, and due to the absence of a polarization converting unit, there are limitations to increasing the light efficiency. Thus, intensive studies for developing a polarization light guide panel which performs a polarization separating and converting function are required.

Related art methods for converting polarization include a method of converting a phase using a liquid crystal cell or a ¼ wavelength plate which exploit anisotropic properties of materials and a method using a thin film coating or a Fresnel rhomb which exploit phase changes caused by total reflections. In addition, the methods include a method using scattering.

Methods involving ¼ wavelength plates are typically expensive, and in the case of light having a polarization direction at 0 degrees or 90 degrees with a polarization axis, polarization conversion is not performed.

### SUMMARY OF THE INVENTION

Exemplary embodiments of the present invention provide a polarization converting light guide panel unit in which a polarization converting performance is improved and a light efficiency is improved, and a display device having the same.

According to an aspect of the present invention, there is provided a polarization converting light guide panel unit including: a light guide panel which guides light emitted by a light source and comprises a light transmission pattern through which the light is incident to the light guide panel or exits from the light guide panel and which is disposed on a bottom surface of the light guide panel; and a polarization converting device disposed below the light guide panel, which converts the polarization of light transmitted through the light transmission pattern and transmits the converted light toward the light guide panel.

According to another aspect of the present invention, there is provided a display device including: a polarization converting light guide panel unit, the polarization converting light guide panel unit comprising a light guide panel which guides light emitted by a light source and comprises a light transmission pattern through which the light is incident to the light guide panel or exits from the light guide panel and which is disposed on a bottom surface of the light guide panel, and a polarization converting device disposed below the light guide panel, which converts the polarization of light transmitted through the light transmission pattern and transmits the converted light toward the light guide panel; and a display panel forming an image using light emitted from the polarization converting light guide panel unit.

### BRIEF DESCRIPTION OF THE DRAWINGS

The above and other aspects of the present invention will become more apparent from the following detailed description of exemplary embodiments thereof with reference to the attached drawings in which:

FIG. 1 is a schematic cross-sectional view of a structure of a polarization converting light guide panel unit according to an exemplary embodiment of the present invention;

FIGS. 2A through 2C are perspective views of polarization converting devices according to exemplary embodiments of the present invention;

FIG. 3 is a plan view of a polarization converting device according to another exemplary embodiment of the present invention;

FIG. 4 is a cross-sectional view of a path of light passing into a polarization separation layer;

FIG. 5 illustrates a path on which light incident on a polarization converting device is reflected from surfaces of a polarization converting pattern;

FIGS. 6A and 6B illustrate predetermined dimensions used to calculate a polarization converting efficiency of a polarization converting device according to exemplary embodiments of the present invention;

FIGS. 7A through 7D are graphs illustrating distribution of light that is polarization converted by a polarization converting device with respect to emission angle when an angle of incidence of light on the polarization converting device is 45°, 55°, 65°, and 75°, respectively; and

FIG. 8 is a schematic cross-sectional view of a display device according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements, and thus their description will be omitted.

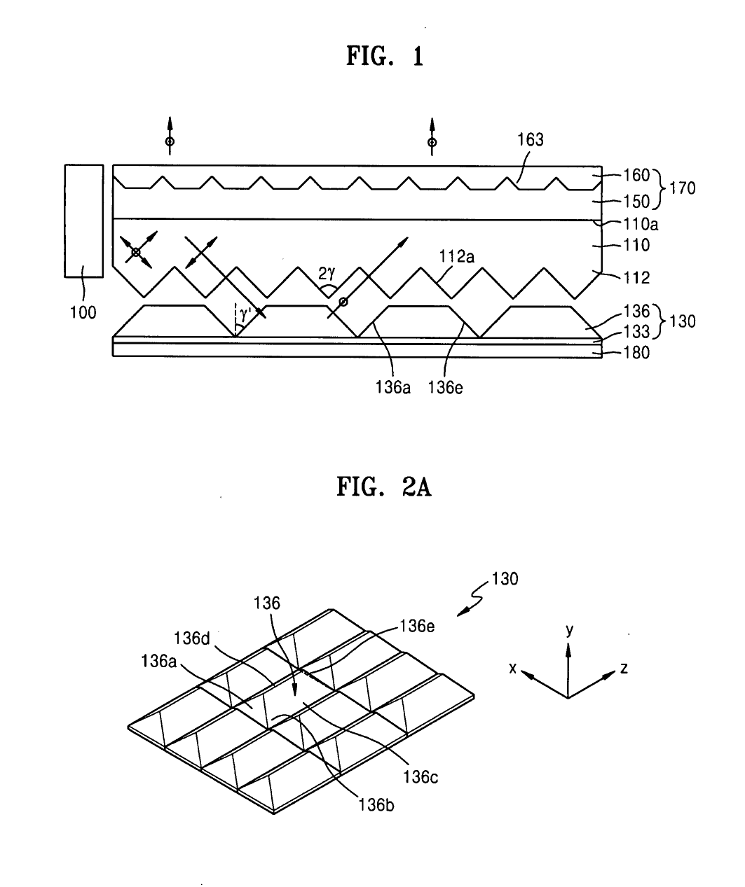

FIG. 1 is a schematic cross-sectional view of a structure of a polarization converting light guide panel unit according to an exemplary embodiment of the present invention. Referring to FIG. 1, the polarization converting light guide panel unit includes a light guide panel 110 which guides light from a light source 100, and a polarization converting device 130 which is disposed below the light guide panel 10 and converts a polarization of light transmitted through a bottom surface of the light guide panel 110. In addition, the polarization converting light guide panel unit may further include a polarization separation layer 170 which is disposed on a top surface of the light guide panel 10 and selectively transmits or reflects light according to the polarization of light transmitted through the top surface of the light guide panel 110. In addition, a reflection plate 180 or a scattering plate (not shown) may be further disposed below the polarization converting device 130.

The light guide panel 10 transmits a portion of incident light emitted from the light source 100 in a downward direction toward the polarization converting device 130 and guides polarization-converted and incident light, to be transmitted, in an upward direction. To this end, a light transmission pattern 112 is formed on the bottom surface of the light guide panel 110. That is, the light transmission pattern 112 allows incident light emitted from the light source 100 to not be totally reflected from the bottom surface of the light guide panel 110 but to be emitted in a downward direction of the light guide panel 110. The light transmission pattern 112 may be formed in a prism shape, for example. The light guide panel 110 is formed of a transparent material that can transmit incident light and may be formed of an optically isotropic material such as polymethylmethacrylate (PMMA) or polycarbonate (PC).

The polarization separation layer 170 may be provided on the top surface of the light guide panel 110. The polarization separation layer 170 separates light emitted from the light source 100 according to the polarization of the light and transmits light of a first polarization, for example, light of an S polarization, and totally reflects light of a second polarization, for example, light of a P polarization, whereby reflected light is transmitted in a downward direction into the light guide panel 110. To this end, the polarization separation layer 170 includes an isotropic adhesion layer 150 formed of an optically isotropic material and an anisotropic transmission layer 160 in which an transmission pattern 163 is formed. The isotropic adhesion layer 150 is formed of a material having the same or almost the same refraction index as that of the light guide panel 110. The anisotropic transmission layer 160 is formed of optically anisotropic material having different refractive index according to the direction of polarization. For example, the anisotropic transmission layer 160 is formed by stretching a polymer sheet, such as polyethylene terephthalate (PET) or polyethylene naphthalate (PEN), in one direction. The refractive index of the anisotropic transmission layer 160 is larger than that of the isotropic adhesion layer 150 with respect to light of the first polarization and is the same or almost the same as that of the isotropic adhesion layer 150 with respect to light of the second polarization.

The polarization converting device 130 is disposed below the light guide panel 110. The polarization converting device 130 converts polarization of incident light transmitted through the light transmission pattern 112 and emits the converted light back toward the light transmission pattern 112. To this end, the polarization converting device 130 includes a polarization converting pattern 136 and the polarization converting pattern 136 includes a plurality of surfaces 136a and 136e. The number and an angle of inclination γ′ of the surfaces 136a and 136e is determined in consideration of solid shapes, for example, a vertical angle 2γ of a prism of the light transmission pattern 112 or distribution of an incident angle of light incident on the light transmission pattern 112. For good coupling efficiency of light emitted from the light transmission pattern 112 with the polarization converting device 130, half of the apex angle of a prism of the light transmission pattern 112 may be the same as the angle of inclination, that is, γ=γ′. For example, the polarization converting device 130 can be formed by arranging a base film 133 and a plurality of polarization converting patterns 136 on the base film 133 in a two-dimensional array. In addition, the surfaces 136a and 136e of the polarization converting pattern 136 may be planar or curved.

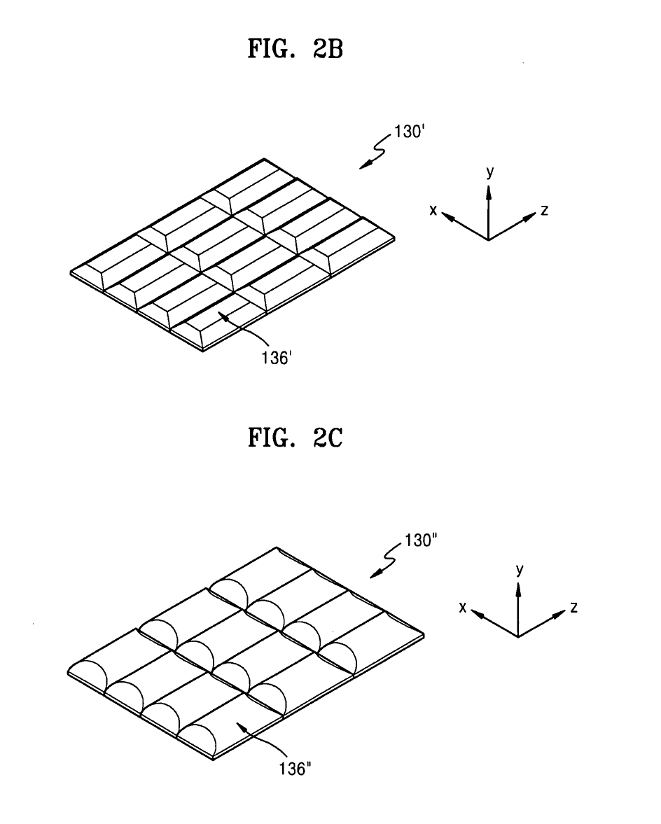

FIGS. 2A through 2C are perspective views of a polarization converting devices according to exemplary embodiments of the present invention. Referring to FIGS. 2A and 2B, the polarization converting pattern 136′ is formed in a pentahedral or hexahedral shape in which a cross-section of the polarization converting pattern 136(136′) from an X-Y plane is a triangular or trapezoidal shape. Referring to FIG. 2C, the polarization converting pattern 136″ has a curved surface. Thus, a cross-section of the polarization converting pattern 136″ from the X-Y plane is a semicircular shape.

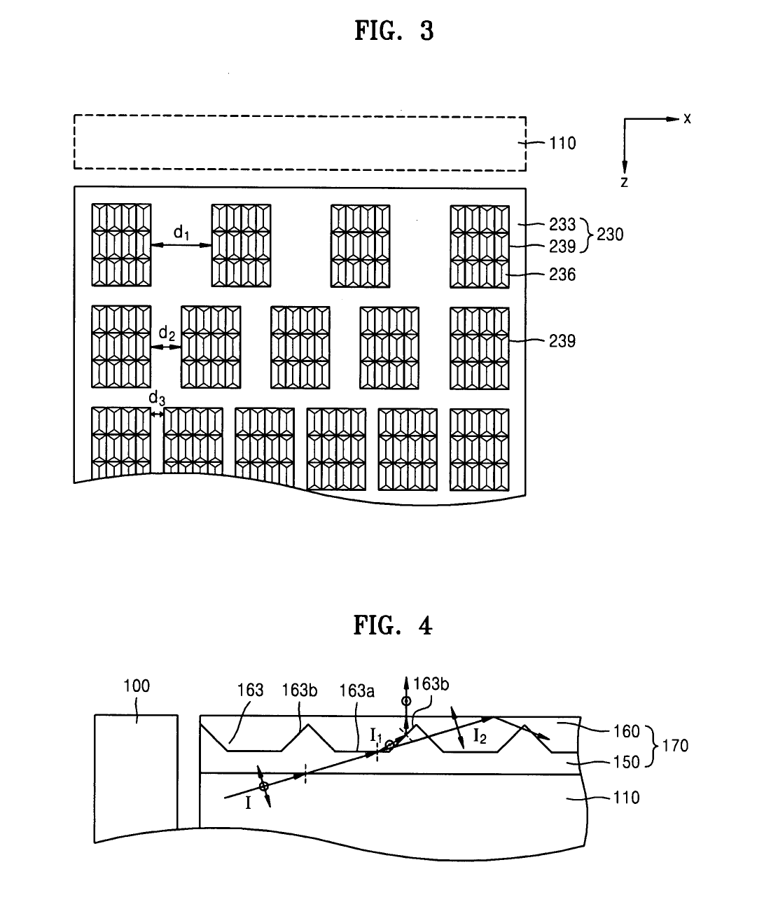

FIG. 3 is a plan view of a polarization converting device according to another exemplary embodiment of the present invention. Referring to FIG. 3, a polarization converting device 230 has a structure in which a base film 233 and a plurality of pattern units 239, in which a plurality of polarization converting patterns 236 are arranged in a two-dimensional array, are arranged on the base film 233. The pattern units 239 are arranged at regular intervals along a first direction toward/away from the light source 110 and a second direction perpendicular to the first direction. In the drawing, the first and second directions are Z- and X-directions, respectively. In this case, intervals arranged along the second direction become smaller the further the pattern units 239 are from the light source 110. For example, when the intervals arranged along the second direction are indicated by d₁, d₂, and d₃, then d₁>d₂>d₃ as the pattern units 239 having intervals of d₁ are closer to the light source 110 than the pattern units 239 having intervals of d₂ etc. As the pattern units 239 are gradually distant from the light source 110, a density at which the pattern units 239 are arranged becomes complex. This means that a higher proportion of the total light incident on the patterns undergoes polarization conversion in a position in which the amount of light is relatively small so that the entire brightness becomes uniform.

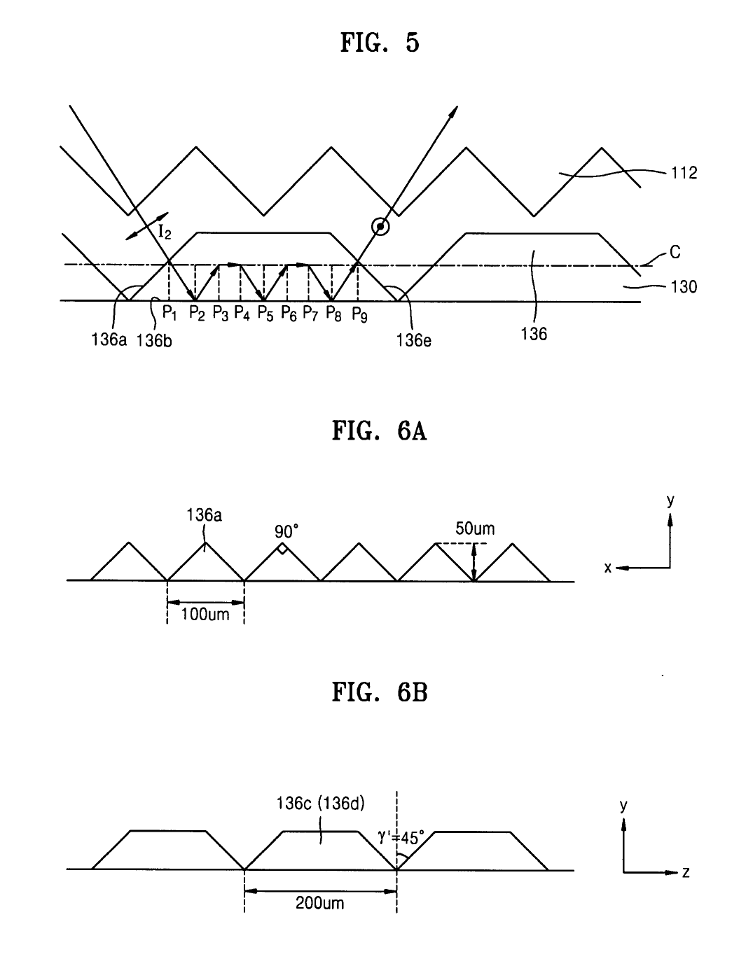

The operation of the polarization converting light guide panel unit having the above structure will now be described with reference to FIGS. 4 and 5. FIG. 4 is a cross-sectional view of a path of light passing into the polarization separation layer 170. Referring to FIG. 4, light of a direction denoted by arrow I is emitted from the light source 100 to the top surface of the light guide panel 110 and is incident on the polarization separation layer 170. Since an isotropic adhesion layer 150 is formed of almost the same as a refractive index of the light guide panel 110, incident light is transmitted through the isotropic adhesion layer 150 without refraction or reflection, and is incident on the anisotropic transmission layer 160. Since the anisotropic transmission layer 160 has a larger refractive index than that of the isotropic adhesion layer 150 with respect to light I₁ of a first polarization direction, the light I₁ of the first polarization direction is refracted and transmitted through a first surface 163a, is totally reflected at a second surface 163b, and is transmitted in an upward direction. Since the refractive index of the anisotropic transmission layer 160 with respect to light I₂ of second polarization is the same as that of the isotropic emission layer 150, the light I₂ of the second polarization direction is not refracted, but rather is transmitted through the transmission pattern 163, is totally reflected at the top surface of the anisotropic transmission layer 160, and is transmitted in a downward direction toward the light guide panel 110. Light that is directed in the downward direction toward the light guide panel 10 is emitted by the light transmission pattern 112 and is incident on the polarization converting device 130. FIG. 5 illustrates a path on which light incident on the polarization converting device 130 is reflected from surfaces of the polarization converting pattern 136. Points indicated by P₁ through P₉ in the drawing represent a path on which light sequentially passes a third surface 136a, a fourth surface 136b, a fifth surface 136c, a sixth surface 136d, the fourth surface 136b, the fifth surface 136c, the sixth surface 136d, and a seventh surface 136e, and is transmitted. A dotted line C is indicated to show a point at which the light intersects with the fifth surface 136c and the sixth surface 136d. The path of light that passes through the surfaces 136a through 136e depends on the angle of incidence of light incident on the polarization converting pattern 136. For example, the light may be transmitted after passing the fifth surface 136c and the sixth surface 136d, respectively, only once or more than three times. When the light is incident on the third surface 136a, it is polarized in a second polarization direction that is not transmitted upwardly through the polarization separation layer 170. The phase of the light changes when the light is reflected from the surfaces 136b through 136d, and when the light is emitted through the seventh surface 136e, the light has a different polarization state than it did prior to being incident through the third surface 136a. The polarization of light emitted through the seventh surface 136e may be changed by 90 degrees with respect to the polarization direction of the light when it is incident on the third surface 136a.

FIGS. 6A and 6B illustrate predetermined dimensions used to calculate a polarization converting efficiency of a polarization converting device according to exemplary embodiments of the present invention. The polarization converting device 136 uses the shape of FIG. 2A. FIG. 6A represents a cross-sectional dimension in an X-Y plane of FIG. 2A. FIG. 6B represents a cross-sectional dimension in a Y-Z plane of FIG. 2A. The polarization converting device 136 is formed of polymethylmethacrylate (PMMA) having a refractive index of 1.49. Polarization converting efficiency in % according to an incident angle is shown in Table 1.

TABLE 1

| | Polarization converting | Polarization converting |
|---|---|---|
| Incident angle | efficiency, S→S | efficiency, P→S |
| 45° | 26.7 | 53.7 |
| 55° | 43.3 | 45.1 |
| 65° | 45.7 | 44.6 |
| 75° | 39.1 | 34.1 |
| Average | 38.7 | 44.4 |

Since the polarization converting light guide panel unit is used to ideally transmit only light having a polarization in one direction, the polarization converting efficiency is shown as an efficiency of S polarization. That is, Table 1 shows the ratio at which the light of S polarization is not polarization converted but is emitted as S polarization, when the entire light of S polarization incident on the polarization converting device is 100, and the ratio at which the light of P polarization is converted into S polarization and is emitted, when the entire light of P polarization is 100. Referring to Table 1, the ratio at which light of S polarization is transmitted as light of S polarization is about 38.7% on average and the ratio at which light of S polarization is converted into light of P polarization and is transmitted is about 44.4%. The result shows a polarization converting efficiency of only the polarization converting device 130. When the polarization separation layer 170 is provided together with the polarization converting device 130, light of polarization that is separated from the polarization separation layer 170 and is not emitted is mainly incident on the polarization converting device 130 and is polarization converted. Thus, the ratio at which light of S polarization is transmitted is higher than that when only the polarization converting device 130 is provided.

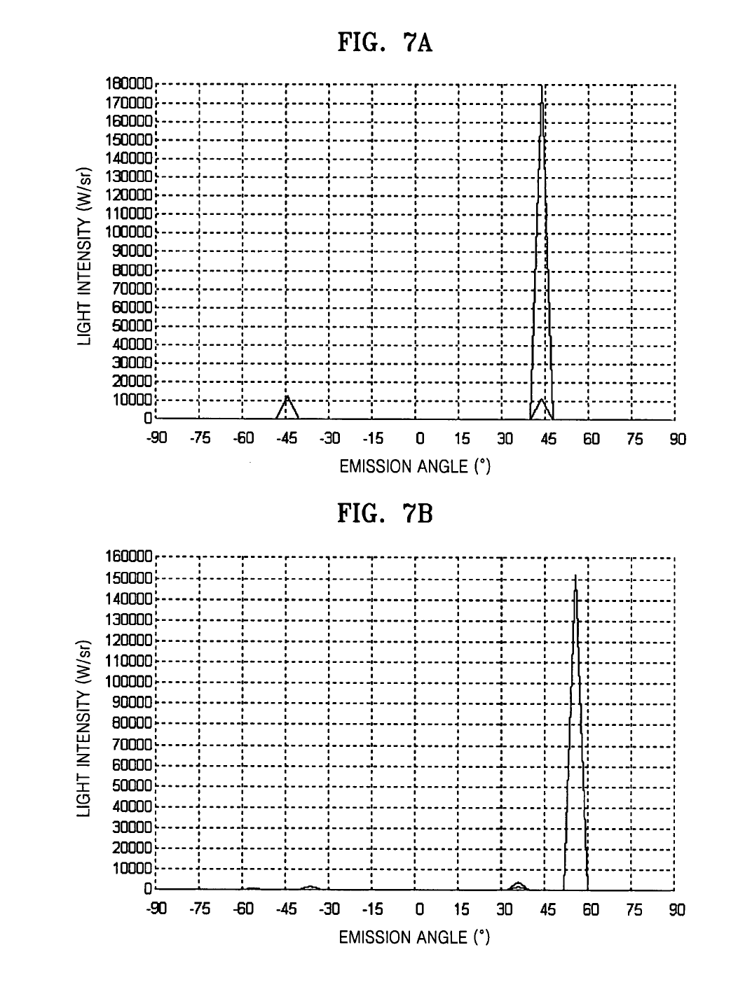

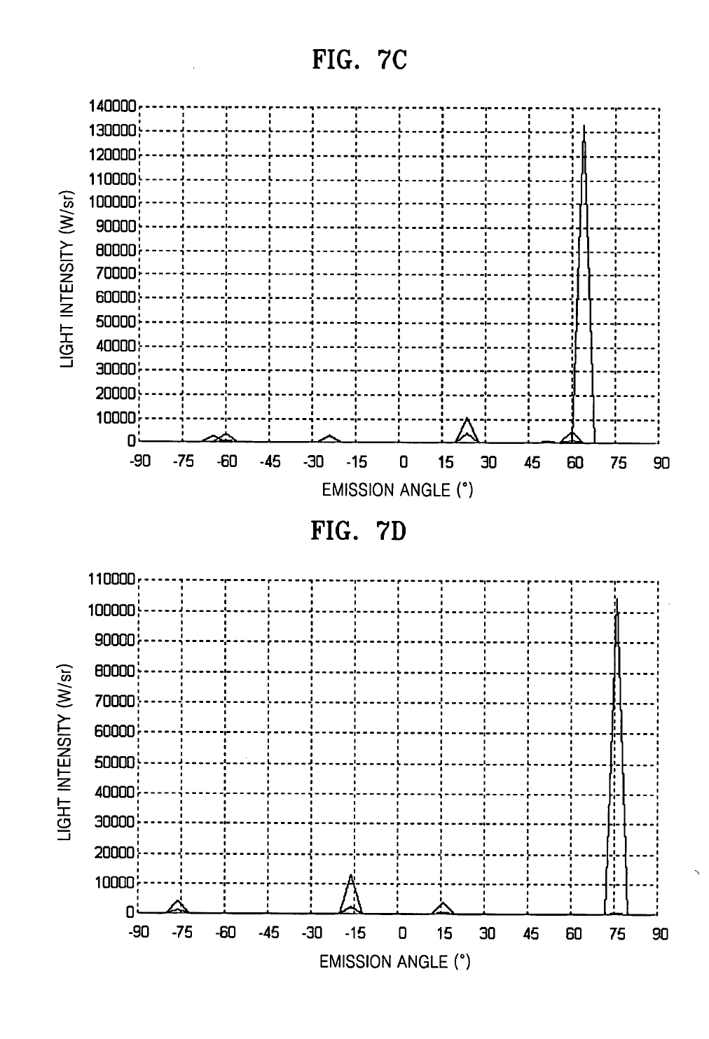

FIGS. 7A through 7D are graphs illustrating distribution of light that is polarization converted by a polarization converting device with respect to an emission angle when an angle of light incident on the polarization converting device is 45°, 55°, 65°, and 75°, respectively. The incident angle and the emission angle represent an angle between a normal of the top surface of the light guide panel 110 and incident light and an angle between the normal of the top surface of the light guide panel 110 and emission light, respectively. Referring to FIGS. 7A through 7D, light intensity is highest at the emission angle which is the same as the incident angle. That is, the amount of light is concentrated where the emission angle is almost the same as the incident angle. The emission angle is to be an incident angle at which light is re-incident on the light guide panel 110 through the light transmission pattern 112 on the bottom surface of the light guide panel 110, that is, re-incident angles. Light whose incident angle on the polarization converting device 130 and re-incident angle on the light guide panel 110 are almost the same, that is, light whose polarization is converted and which is re-incident on the light guide panel 110, is incident on the polarization separation layer 170 at the same angle when the light is separated from the polarization separation layer 170 in a previous step. In this step, a larger portion of light incident on the polarization separation layer 170 is emitted in an upward direction of the light guide panel 110

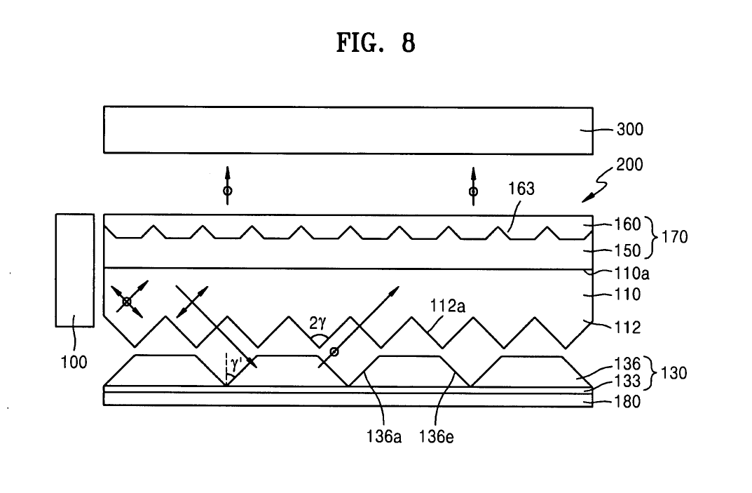

FIG. 8 is a schematic cross-sectional view of a display device according to an exemplary embodiment of the present invention. Referring to FIG. 8, the display device includes a light source 100, a polarization converting light guide panel unit 200, and a display panel 300A line light source such as a cold cathode fluorescent lamp (CCFL) or a point light source such as a light emitting diode (LED) may be used as the light source 100. The structure and operation in which the polarization converting light guide panel unit 200 converts polarization of light emitted from the light source 100 and transmits light polarized in one direction are described above. Although the polarization converting device 130 of FIG. 2A is shown in the polarization converting light guide panel unit 200, the polarization converting device (130′ of FIG. 2B, 130′ of FIG. 2C, and 230 of FIG. 3) of FIGS. 2B, 2C or 3 may also be used in the polarization converting light guide panel unit 200. The display panel 300 may be, for example, a liquid crystal panel which forms an image using light transmitted by the polarization converting light guide panel unit 200.

As described above, in the polarization converting light guide panel unit having the above structure according to exemplary embodiments of the present invention, a light emission/incident unit is disposed on a bottom surface of a light guide panel and a polarization converting device is disposed below the light guide panel. The polarization converting light guide panel unit has the following effects. First, by a method of converting polarization using a phase change caused by reflection, unlike a related art polarization converting method using properties of anisotropy, polarization conversion can be performed with respect to polarization in which an angle with a polarization axis is 0 degree or 90 degrees so that a polarization converting efficiency can be increased. In addition, manufacturing costs can be reduced and the polarization converting light guide panel unit can be easily manufactured. Second, distribution of a polarization converting pattern can be adjusted, thereby adjusting the amount of emission light so that brightness uniformity is improved. Third, a display device having the polarization converting light guide panel unit has low power consumption and excellent picture quality.

While the present invention has been particularly shown and described with reference to exemplary embodiments thereof, it will be understood by those of ordinary skill in the art that various changes in form and details may be made therein without departing from the sprit and scope of the present invention as defined by the following claims.

What is claimed is:

1. A polarization converting light guide panel unit comprising:
a light guide panel, which guides light emitted by a light source, comprising a light transmission pattern which is disposed on a bottom surface thereof; and
a polarization converting device, disposed below the light guide panel, which converts the polarization of light transmitted through the light transmission pattern, and transmits the light toward the light guide panel.

2. The polarization converting light guide panel unit of claim 1, wherein
the light transmission pattern comprises a surface inclined with respect to a top surface of the light guide panel.

3. The polarization converting light guide panel unit of claim 1, wherein the light transmission pattern is a prism pattern.

4. The polarization converting light guide panel unit of claim 1, wherein the polarization converting device comprises:
a base film; and
a polarization converting pattern, disposed on the base film, and comprising a plurality of surfaces.

5. The polarization converting light guide panel unit of claim 4, wherein the plurality of surfaces are planar or curved.

6. The polarization converting light guide panel unit of claim 4, wherein the plurality of surfaces are formed so that an angle of light incident on the polarization converting pattern and an angle at which the polarization converted light is emitted are the same with respect to a normal of a top surface of the light guide panel.

7. The polarization converting light guide panel unit of claim 4, wherein the polarization converting pattern is arranged on the base film in a two-dimensional array.

8. The polarization converting light guide panel unit of claim 4, wherein
the polarization converting device comprises a plurality of pattern units in which the polarization converting pattern is arranged in a two-dimensional array, and
the plurality of pattern units are spaced apart from one another on the base film.

9. The polarization converting light guide panel unit of claim 8, wherein
the pattern units are disposed on the base film at regular intervals along a first direction that extends away from the light source and at intervals along a second direction that is perpendicular to the first direction, and
the intervals of the pattern units along the second direction become smaller for pattern units disposed further from the light source.

10. The polarization converting light guide panel unit of claim 1, further comprising a polarization separation layer which separates light incident on a top surface of the light guide panel according to the polarization of the light.

11. The polarization converting light guide panel unit of claim 10, wherein the polarization separation layer comprises:
an isotropic adhesion layer comprising an optically isotropic material; and
an anisotropic transmission layer, disposed on the isotropic adhesion layer, comprising an optically anisotropic material, and having a transmission pattern.

12. The polarization converting light guide panel unit of claim 11, wherein the transmission pattern comprising a first surface parallel to the top surface of the light guide panel and a second surface inclined with respect to the top surface of the light guide panel.

13. The polarization converting light guide panel unit of claim 11, wherein a refractive index of the isotropic adhesion layer is the same as a refractive index of the light guide panel.

14. The polarization converting light guide panel unit of claim 1, further comprising, disposed on a bottom surface of the polarization converting device, one of a reflection plate and a scattering plate.

15. A display device comprising:
a polarization converting light guide panel unit, the polarization converting light guide panel unit comprising:
a light guide panel, which guides light emitted by a light source, comprising a light transmission pattern, disposed on a bottom surface thereof; and
a polarization converting device, disposed below the light guide panel, which converts the polarization of light transmitted through the light transmission pattern, and transmits the converted light toward the light guide panel; and
a display panel forming an image using light emitted from the polarization converting light guide panel unit.

16. The display device of claim 15, further comprising a polarization separation layer which separates light incident on a top surface of the light guide panel according to the polarization of the light.
